(19) United States
(12) Patent Application Publication
(10) Pub. No.: US 2009/0178291 A1
(43) Pub. Date: Jul. 16, 2009

(54) STRUCTURE FOR END PIECE OF A TAPE RULE

(76) Inventor: Jason Huang, Taipei (TW)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/015,004

(22) Filed: Jan. 16, 2008

(51) Int. Cl. G01B 3/10

(52) U.S. Cl. 33/770; 33/758

(57) ABSTRACT

The present invention relates to an improvement of tape rule, in particular to end piece of the tape rule which includes measuring tape connecting portion and hook hanging portion, both parts are made of same material as a whole body. The hook hanging portion of measuring tape contains at least one space, inside the space, there is an absorbing member which can be easily detached from the hook plate by people without using a hand tool.

### BACKGROUND OF THE INVENTION

1. Field of the Invention

The present invention relates to an improvement of tape rule, in particular to the hook plate of end piece of the measuring tape. An absorbing member is put in the space formed of hook plate, and the absorbing member can be easily detached from the end piece of tape rule without using a hand tool.

2. Description of Prior Art

It is known to public that the tape rule is a motive and convenient measuring tool. As shown in FIG. 1, in general, the measuring tape 12 of connectional tape rule is reserved in a housing 11. At the end portion of the measuring tape 12, there is an end piece 13. Said end piece 13 contains a connecting plate 14 to be attached onto the end of the measuring tape 12, and a hook plate 15 perpendicularly extended from the connecting plate 14. In using the tape rule, by using the hook plate 15 of the end piece 13, it is merely necessary for people to pull the end piece 13 and then put the end piece 13 against the surface of an article or hook onto the end of the article to be measured.

However, said end piece 13 of tape rule has some disadvantages as follows:

In order to make the hook plate of the end piece be connected to the measuring tape as an entity, and to prevent inconvenience of carrying the tape rule due to the end piece, the area of hook plate is made as small as possible. However, if the area of hook is too small, it is difficult to hook onto an article and easy to slide away from the article to cause inaccurate measurement, to improve such problem happened in the end piece of conventional tape rules, U.S. Pat. No. 6,546,644 B2 discloses an end piece for attachment to the end of measuring tape. A cross curvature tape measure supports its own weight when it is extended horizontally and is held in an upright position. A perpendicular hook at the end of the measuring tape can be used to secure the end of the measuring tape to an edge of an object. A hook that extends above the curved surface of the measuring tape allows measurements to be secured from below an object while maintaining the upright and self supporting position of the tape. An adhering or magnetic means attached at the end of the measuring tape further assists in allowing measurements to be taken without causing the incidental collapse of the measuring tape. Such and end piece may be removably attached, and may be adapted to fit on existing tape measures. US Patent Application No. 2004/0064962A1 also discloses a soft stop-proof hook head of a measuring tape is located at one end of the measure tape and comprises a ruler hook. A surface of a ruler hook is enclosed by a soft elastomer. The soft elastomer is made of a flexible material. When the soft elastomer is pressed, it generates an elastic resistance; in measuring, the ruler hook is coupled to a measured bench mark of an object to be measured with a slide-stop effect. Moreover, the soft elastomer is extended with a slide piece for enhancing the slide-stop effect.

From the above two former applications, they all install magnetic object to front end of the end piece of measure tape, such that when the end piece is in contact with object made of metals, according to the magnetic nature of the end piece, the said object will be attached to the end piece of measuring tape. To increase the strength and stability of attachment are also designer and manufacturer's object of improvement.

However, the above mentioned structures depend on the magnetic object being firmly installed to the end piece, then the absorbing function of magnetic object would cause the end piece being attached with iron crumbs etc. all the time, this would generate inconvenience and troublesome to the user. Furthermore, because the magnetic object of end piece is extruded outside the end piece, the parts are easily fall apart due to repeat contact in use. In addition, the installment of magnetic object onto the end piece of a tape rule would increase the thickness of end piece, and then accordingly reduce the precision of measurement of tape rule.

In order to overcome the inconvenience of the design of the above cases, the inventor of present invention has experiment, conduct research and make improve of present invention to reach its final outcome.

### SUMMARY OF THE INVENTION

It is an object of the present invention to provide an improved structure for the end piece of tape rule, that is to insert an absorbing member having a magnetic object in the hook plate as a whole body.

According to the improved structure of the end piece of present invention, the hook plate of the end piece has a space to hold an absorbing member formed of or having a magnetic object, after the said absorbing member is put into the said space, then the whole thickness of the hook plate would not be changed, then the precision of tape rule shall be maintained.

According to the improved structure of the end piece of present invention, the absorbing member can be easily detached from the hook plate without using a hand tool by the user when it is not necessary for people to use the absorbing member, then the inconvenience and troublesome to people due to absorbing function of magnetic object would be prevented.

A more complete understanding of these and other features and advantages of the present invention will become apparent from a careful consideration of the following detailed description of preferred embodiments illustrated in the accompanying drawings.

### BRIEF DESCRIPTIONS OF THE DRAWINGS

FIG. 1 is a perspective view of conventional tape rule.

FIGS. 2a & 2b are the perspective views showing the construction of the hook plate of the present invention.

FIGS. 3a & 3b are the perspective views showing another preferred embodiment of the construction of the hook plate of the present invention.

FIGS. 4a & 4b are the perspective views showing a further preferred embodiment of the construction of the hook plate of the present invention.

### DETAILED DESCRIPTION OF THE PREFERRED EMBODIMENTS

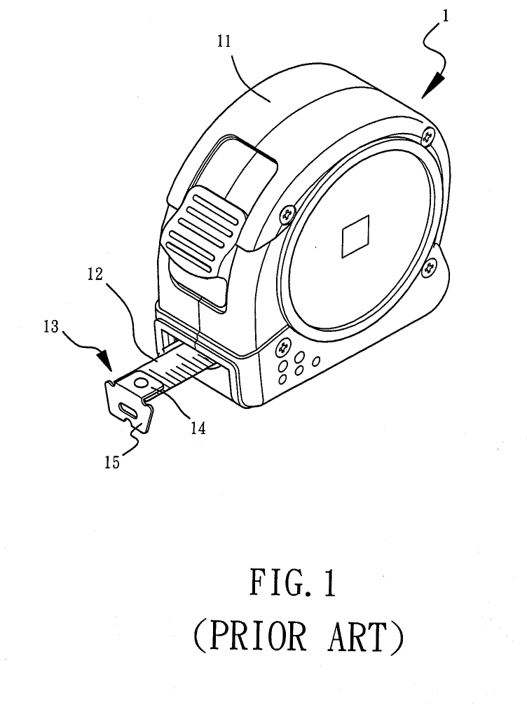

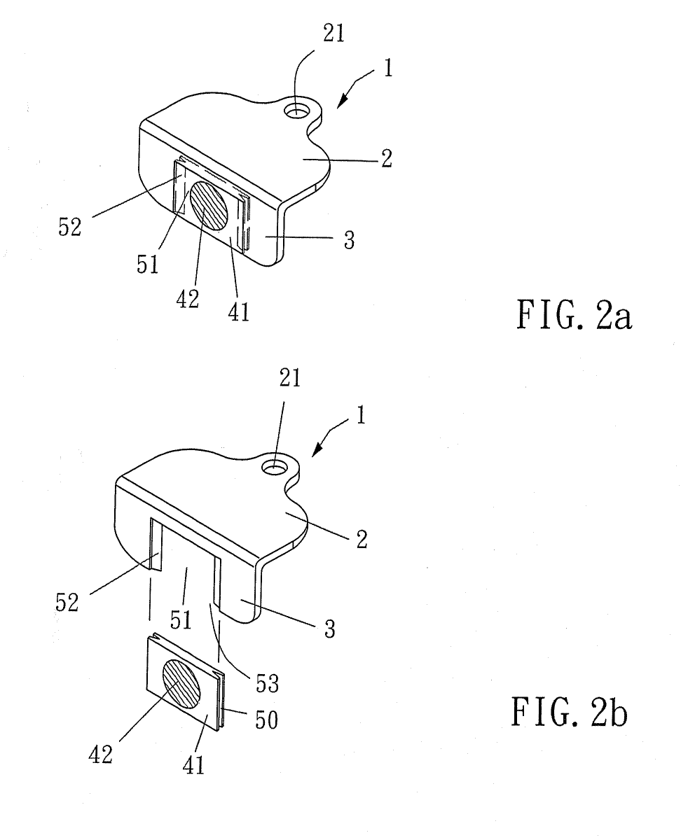

According to the improved structure for the end piece of the tape rule of the present invention, as shown in FIGS. 2a and 2b, the end piece 1 includes a measuring tape connecting portion 2 and a hook plate 3. The measuring tape connecting portion 2 and the hook plate 3 are made by metal to form a whole body. There are pin holes 21 for rivets to insert into and connect the end piece 1 to be firmly attached to the surface of measuring tape (the portion of tape rule denoted by 12 shown in FIG. 1).

On the said hook plate 3, there is installed an absorbing member having a magnetic object 42 or being formed by a magnetic object. The absorbing member 41 has a thickness identical to the hook plate 4, and it can be easily detached from the hook plate 4 or put in the hook plate 4 without using a hand tool.

Thus if people wishes to use the function of magnetic object, the absorbing member 41 is firstly installed in said hook plate 3, then the end piece 2 of tape rule can be used to obtain iron pieces left in a place that people can not reach, or to measure an object having an end that is difficult for people to firmly fix the end piece of tape rule on it without using the magnetic force. When it is not necessary to use the absorbing member 41, the absorbing member 41 can be easily detached from the hook plate 3 of the end piece 2 without using a hand tool by the user, then the inconvenience and troublesome due to absorbing function of magnetic object would not be occurred.

As shown in FIGS. 2a & 2b, in a preferred embodiment of present invention, said absorbing member 41 having a magnetic object 42 in it or being formed by a magnetic is a rectangular chip, a sliding furrow 50 is formed at each of its side surfaces; the hook plate 3 also has formed a rectangular opening 51 corresponding to the absorbing member 41, each of the side edges of said rectangular opening 51 is formed as a sliding edge 52 which has a width and a depth same as said sliding furrow 50, such that the sliding edge 52 can be mounted into said sliding furrow 50. Then the absorbing member 41 can be easily installed onto the hook plate 3 via the mouth 53 of said rectangular opening 51 formed in the hook plate 3, or detached from the hook plate 3.

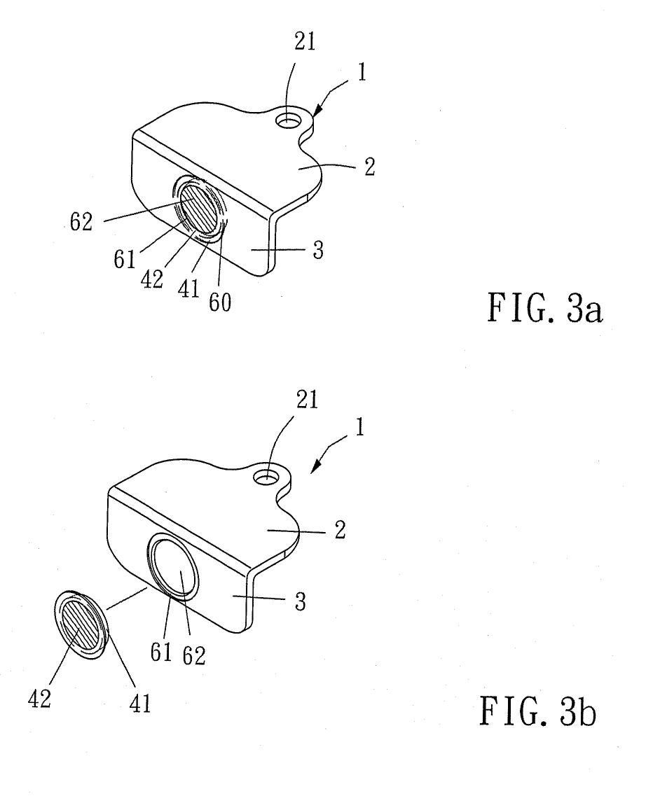

As shown in FIGS. 3a & 3b, in another preferred embodiment of present invention, said absorbing member 41 is formed as a small cylinder, the rear section of the absorbing member 41 is formed as a mounting portion 60. While the hook plate 3 of end piece 1 is also formed with a mounting hole 61 corresponding to said mounting portion 60. The mounting hole 61 also has a mounting section 62 corresponding to the mounting portion 60 of said absorbing member 41, such that by mounting the absorbing member 41 in the mounting hole 41, the absorbing member 41 can be easily installed onto the hook plate 3 or detached from the hook plate 3.

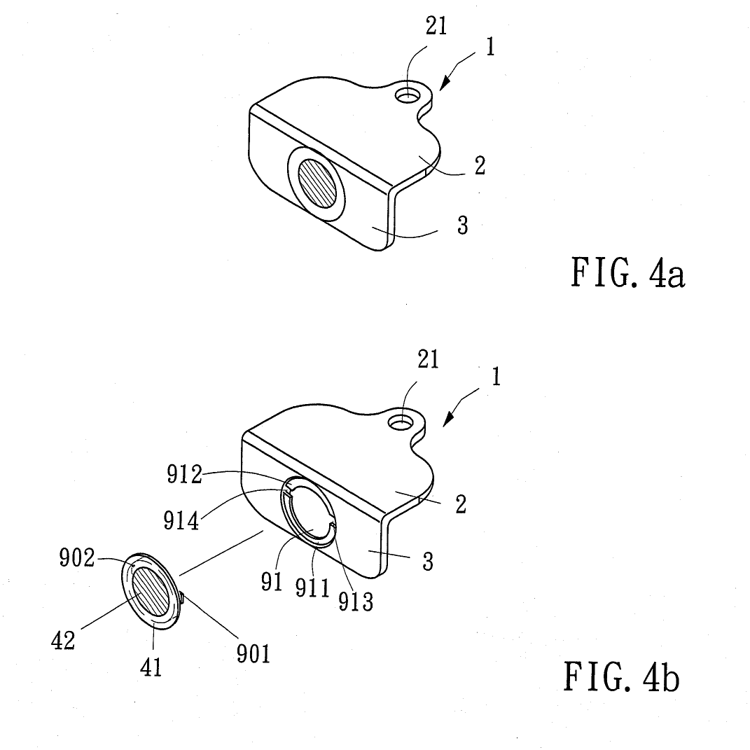

As shown in FIGS. 4a & 4b, in a further preferred embodiment of present invention, said absorbing member 41 is formed as a flat cylinder of two sections. The upper section of absorbing member 41 has a larger diameter than its lower section 94, and a pair of extrudes 901, 902 are separately formed on the surrounding surface of said lower section 94. While the hook plate 3 of end piece 1 is also formed with a mounting hole 91 having a shape corresponding to the absorbing member 41. That is, a pair of arc stoppers 911, 912 is separately formed on the inner wall of the mounting hole 91, and the gaps between the arc stoppers 911, 912 are allowed for the extrudes 901, 902 formed on the surrounding surface of said absorbing member 41 to pass through, then when the absorbing member 41 is put into the mounting hole 91 of hook plate 3, the extrudes 901, 902 will pass through the gaps 931, 932 between said arc stoppers 911, 912, after the absorbing member 41 is rotated for a certain degree, the extrudes 901, 902 then are stopped by the arc stoppers 911, 912. As a result, the absorbing member 41 is firmly hold inside the mounting hole 91 of the hook plate 3. When it is not necessary for people to use the absorbing member 41, simply rotate the absorbing member 41 with finger to make the extrudes 901, 902 be placed at the gaps 931, 932 between said arc stoppers 911, 912, the extrudes 901, 902 of absorbing member 41 then would not be stopped by the arc stoppers 911, 912, and the absorbing member can be easily detached from the hook plate 3.

According to the improved structure for the end piece of the tape rule of the present invention, the absorbing member attached to the hook plate can be easily detached, so as to prevent the inconvenience caused due to magnetic object. Since present invention is not disclosed and for sale previously, thus believed present invention is an invention of novelty.

Although the present invention has been described with a certain degree of particularity, the present disclosure has been made by way of example and changes in details of structure may be made without departing from the spirit thereof.

What is claimed is:

1. An improved structure of end piece of tape rule, said end piece comprises:
a measuring tape connecting portion connected horizontally to the end of the measuring tape, therefore the end piece is connected to measuring tape as one piece;
a hook plate, placed at the end of end piece, perpendicularly extended downwardly from the tape connecting portion; article for measurement can be hooked by the hook plate, so measurement can be done;
wherein said hook plate contains at least one space, inside the space, there is an absorbing member which can be easily detached from the hook plate by people without using a hand tool.

2. The improved structure for end piece of a tape rule as claimed in claim 1, wherein said absorbing member is a magnetic object.

3. The improved structure for end piece of a tape rule as claimed in claim 1, wherein said absorbing member has a magnetic object in it.

4. The improved structure for end piece of a tape rule as claimed in claim 1, wherein said absorbing member has a thickness identical to the thickness of hook plate.

5. The improved structure for end piece of a tape rule as claimed in claim 1, wherein the back of said absorbing member has a surface as plain as the back surface of said hook plate.

6. The improved structure for end piece of a tape rule as claimed in claim 1, wherein said absorbing member is a rectangular chip, a pair of sliding furrow are formed on its opposite side surfaces; the hook plate also has formed a rectangular opening corresponding to the absorbing member, each of the two opposite side edges of said rectangular opening is formed as a sliding edge which has a width and a depth same as said sliding furrow, such that the sliding edge can be mounted into said sliding furrow, then the absorbing member can be easily installed onto or detached from the hook plate via the mouth of said rectangular opening formed in the hook plate.

7. The improved structure for an end piece of a tape rule as claimed in claim 1, wherein said absorbing member is formed as a small cylinder, the rear section of the absorbing member is formed as a mounting portion, while the hook plate of end piece is also formed with a mounting hole for holding absorbing member, the mounting hole also has a mounting section corresponding to the mounting portion of said absorbing member, such that by inserting the absorbing member into the mounting hole, the absorbing member can be easily installed onto the hook plate, or, detached from the hook plate when it is not necessary for people to use the absorbing member.

8. The improved structure for an end piece of a tape rule as claimed in claim 1, wherein said absorbing member is formed as a flat cylinder of two sections, the upper section of absorbing member has a larger diameter than its lower section, and a pair of extrudes are separately formed on the surrounding surface of said lower section, while the hook plate of end piece is also formed with a mounting hole having a shape corresponding to the absorbing member, that is, a pair of arc stoppers is separately formed on the inner wall of the mounting hole, and the gaps between the arc stoppers are allowed for the extrudes formed on the surrounding surface of said absorbing member to pass through, then when the absorbing member is put into the mounting hole of look plate, the extrudes will pass through the gaps between said arc stoppers, after the absorbing member is rotated for a certain degree, said extrudes then are stopped by the arc stoppers, as a result, the absorbing member is firmly hold inside the mounting hole of the hook plate, when it is not necessary for people to use the absorbing member, simply rotate the absorbing member to make the extrudes be placed at the gaps between said arc stoppers, the extrudes of absorbing member then would not be stopped by the arc stoppers, and the absorbing member can be easily detached from the hook plate.
